(19) United States
(12) Patent Application Publication
(10) Pub. No.: US 2009/0015850 A1
(43) Pub. Date: Jan. 15, 2009

(54) Rapid loading of interleaved RGB data into SSE registers

(76) Inventor: Kenneth Edward Smith, Camas, WA (US)

Correspondence Address: SHARP LABORATORIES OF AMERICA, INC., 1320 PEARL ST., SUITE 228, BOULDER, CO, 80302, US

(21) Appl. No.: 11/827,849

(22) Filed: Jul. 13, 2007

(51) Int. Cl. G06F 15/00

(52) U.S. Cl. 358/1.9

(57) ABSTRACT

Rapid loading of chromatically interleaved RGB data into SSE registers as chromatically segregated RGB data for print processing is achieved through a loading algorithm that relies on a reduced number of memory references. An exemplary method comprises the steps of loading into SSE registers a first instance of data of a first and a second color from interleaved RGB data two bytes at a time, creating in SSE registers a second instance of the data of the first and second colors, removing from SSE registers one instance of the data of the second color, packing into one SSE register one instance of the data of the first color, removing from SSE registers one instance of the data of the first color and packing into one SSE register one instance of the data of the second color.

### BACKGROUND OF THE INVENTION

The present invention relates to preparation of a red, green and blue (RGB) image for printing, and more particularly to methods and systems for rapid loading of chromatically interleaved RGB data into Streaming Single Instruction, Multiple Data Extensions (SSE) registers as chromatically segregated RGB data for print processing.

Many images, such as images created by digital cameras and scanners, are created in the RGB color space. On the other hand, printers typically print full color images in the cyan, magenta, yellow and black (CYMK) color space. Thus, if it desired to print an image created in the RGB color space on a printer, the RGB image must first be converted into a CMYK image. One step commonly performed attendant to this conversion is loading chromatically interleaved RGB data into SSE registers as chromatically segregated RGB data.

Microprocessors compliant with SSE, including enhanced versions of SSE such as SSE2, SSE3, SSSE3 and SSE4, provide at least eight 16-byte SSE registers that are directly addressable by the register names xmm0 to xmm7. SSE instructions programmed in x86 assembly language are executable by these microprocessors to load chromatically interleaved RGB data into SSE registers as chromatically segregated RGB data. Once loaded, the microprocessor can execute the powerful SSE instruction set to perform parallel operations on the chromatically segregated RGB data and reduce print times.

Unfortunately, due to the structure of the interleaved RGB data, conventional loading of interleaved RGB data into SSE registers as segregated RGB data has been awkward and involved a large penalty. A conventional algorithm first loads from a source register into one or more SSE registers individual bytes of the red data, then loads into one or more different SSE registers individual bytes of the green data, then loads into one or more different SSE registers individual bytes of the blue data. This loading algorithm requires a separate memory reference for each byte of data that is loaded, which slows down processing to an extent that at least partially offsets the speed gains achieved through subsequent parallel processing in the SSE registers.

### SUMMARY OF THE INVENTION

The present invention, in a basic feature, is directed to methods and systems for rapid loading chromatically interleaved RGB data into SSE registers as chromatically segregated RGB data for print processing. Speed gains are realized through a loading algorithm that relies on a reduced number of memory references.

In one aspect of the invention, a system for rapid loading of chromatically interleaved RGB data as chromatically segregated RGB data comprises processing logic, a source storage element adopted to store chromatically interleaved RGB data and a plurality of destination storage elements, wherein the processing logic is adapted to load into a first two destination storage elements a first instance of data of a first and a second color from the chromatically interleaved RGB data two bytes at a time, copy the first instance of data to a second two destination storage elements to produce a second instance of data, remove one instance of data of the second color from two of the destination storage elements, pack one instance of data of the first color into one of the destination storage elements, remove one instance of data of the first color from two of the destination storage elements and pack one instance of data of the second color into one of the destination storage elements.

In some embodiments, the processing logic is further adapted to load from the source storage element into a third two destination storage elements data of the first and a third color from the chromatically interleaved RGB data two bytes at a time, remove the data of the first color from the third two destination storage elements and pack the data of the third color into one of the destination storage elements.

It will be appreciated that by loading chromatically interleaved data two bytes at a time (e.g. red and green data) and relying on copying, removal and packing to produce chromatically segregated data in destination storage elements, memory references for loading chromatically interleaved RGB data are reduced by one-third relative to conventional loading of one byte of RGB data at a time.

In some embodiments, the destination storage elements are SSE registers.

In some embodiments, loading, copying, removal and packing are achieved at least in part through execution of SSE instructions.

In some embodiments, removal is achieved at least in part through masking.

In some embodiments, the first, second and third colors are red, green and blue, respectively.

In some embodiments, at least one of the third two destination storage elements is selected from among the first two and second two destination storage elements.

In another aspect of the invention, a method for rapid loading of interleaved RGB data into SSE registers as chromatically segregated RGB data comprises the steps of loading into SSE registers a first instance of data of a first and a second color from interleaved RGB data two bytes at a time, creating in SSE registers a second instance of the data of the first and second colors, removing from SSE registers one instance of the data of the second color, packing into one SSE register one instance of the data of the first color, removing from SSE registers one instance of the data of the first color; and packing into one SSE register one instance of the data of the second color.

In some embodiments, the method further comprises the steps of loading in SSE registers an instance of data of the second and a third color from interleaved RGB data two bytes at a time, removing from SSE registers the data of the second color and packing into one SSE register the data of the third color.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a source memory, SSE registers and interactions between them in some embodiments of the invention.

FIG. 2 describes a method for rapid loading of chromatically interleaved red and green data into SSE registers as chromatically segregated data in some embodiments of the invention.

FIG. 3 describes a method for loading of chromatically interleaved blue data into an SSE register as chromatically segregated data in some embodiments of the invention.

FIG. 4 shows exemplary pseudocode for implementing the method of FIG. 2.

FIG. 5 shows exemplary pseudocode for implementing the method of FIG. 3.

### DETAILED DESCRIPTION OF A PREFERRED EMBODIMENT

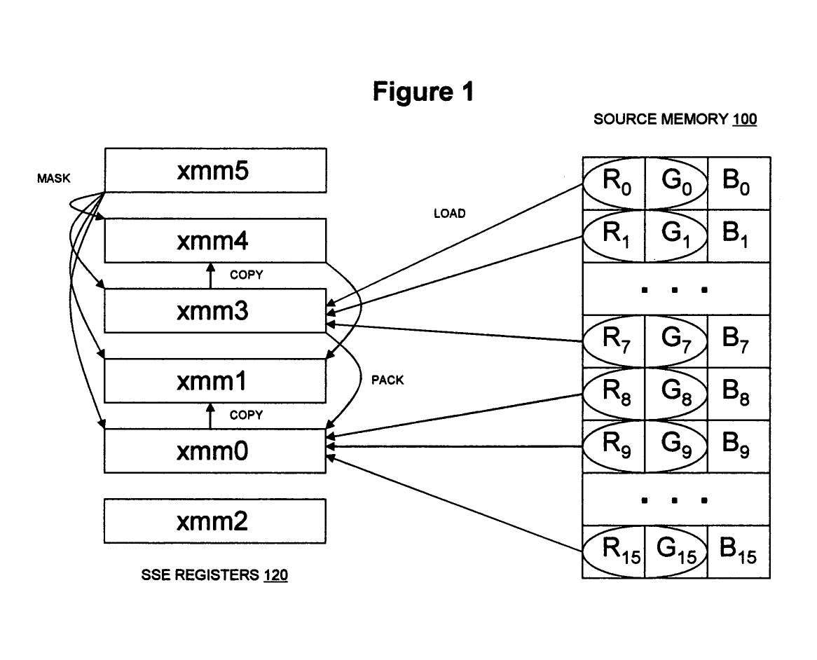

Turning to FIG. 1, a source memory 100, SSE registers 120 and interactions between them are shown in some embodiments of the invention. Source memory 100 includes interleaved RGB data for a color image, such as a digital photograph or a scanned image. For the sake of clarity, RGB data are shown arranged in source memory 100 as contiguous pixel tuples <Rₙ, Gₙ, Bₙ> that include one byte of red data, one byte of green data and one byte of blue data for a pixel of an image. It will be appreciated, however, that source memory 100 may be implemented using a source register that includes contiguous pointer tuples <Rₙ, Gₙ, Bₙ> that point to locations in a memory where one byte of red data, one byte of green data and one byte of blue data for a pixel of an image are stored contiguously or non-contiguously.

SSE registers 120 include six 16-byte registers (xmm0, xmm1, xmm2, xmm3, xmm4 and xmm5) that participate in converting interleaved RGB data loaded from source memory 100 into segregated RGB data stored in SSE registers 120. In the embodiment shown, for example, eight bytes each of interleaved red and green data (R₀, G₀ through R₇, G₇) are loaded two bytes at a time into SSE register xmm3, after which eight more bytes each of interleaved red and green data (R₈, G₈ through R₁₅, G₁₅) are loaded two bytes at a time into SSE register xmm0, after which, through execution of copy, removal and packing operations performed using the SSE instruction set the 16 bytes of green data are segregated from the red data and stored in xmm0 and the 16 bytes of red data are segregated from the green data and stored in xmm1.

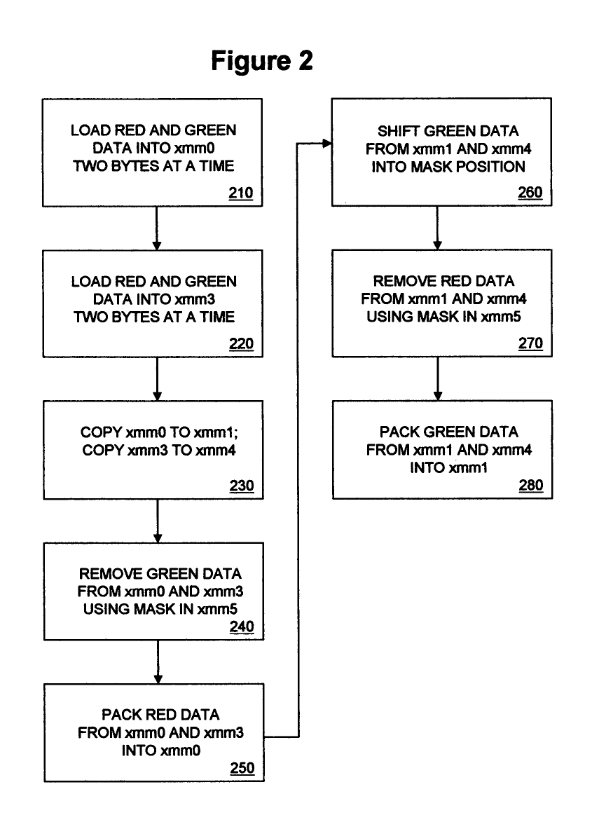

Turning to FIG. 2 in conjunction with FIG. 1, a method for rapid loading of chromatically interleaved red and green data into SSE registers 120 as chromatically segregated data in some embodiments of the invention will now be described in more detail. First, eight bytes each of red and green data are loaded from source memory 100 into SSE register mmx3. Such loading may be accomplished through execution of eight Packed Insert Word (PINSRW) instructions that cause eight two-byte words of red and green data (R₀, G₀ through R₇, G₇) to be moved from source memory 100 into SSE register xmm3 (210) while bypassing eight one-byte words of blue data (B₀ through B₇). Next, an additional eight bytes each of red and green data are loaded from source memory 100 into SSE register xmm0. Such loading may be accomplished through execution of eight PINSRW instructions that cause eight two-byte words of red and green data (R₈, G₈ through R₁₅, G₁₅), respectively, to be moved from source memory 100 into SSE register xmm0 (220). Then, the contents of SSE registers xmm0 and xmm3 are copied to SSE registers xmm1 and xmm4, respectively (230). Such copying may be accomplished through execution of two Packed Shuffle Double Word (PSHUFD) instructions. Next, the 16 bytes of green data are removed from SSE registers xmm0 and xmm3 through a masking operation using a mask stored in SSE register xmm5 (240). Such removal may be accomplished by first loading a mask into SSE register xmm5 through execution of a Load Effective Address (LEA) instruction followed by a Move Double Quadword (MOVDQU) instruction; then removing the green data from SSE registers xmm0 and xmm3 through execution of two bitwise logical AND (PAND) instructions. Then, the 16 bytes of red data from xmm0 and xmm3 are packed into xmm0 (250). Such packing may be accomplished through execution of a Packed with Unsigned Saturation (PACKUSWB) instruction.

Next, the 16 bytes of green data from xmm1 and xmm4 are shifted into mask position (260). That is, the green data are shifted so that application of the mask in xmm5 will result in removal of the red data rather than removal of the green data. Such shifting may be accomplished through execution two Packed Shift Right Logical Quadword (PSRLQ) instructions. Then, the red data are removed from SSE registers xmm1 and xmm4 through a masking operation using a mask stored in SSE register xmm5 (270). Such removal may be accomplished by execution of two bitwise logical AND (PAND) instructions. Then, the green data from xmm1 and xmm4 are packed into xmm1 (280). Such packing may be accomplished through execution of a Packed with Unsigned Saturation (PACKUSWB) instruction.

Through the foregoing steps, data of two colors, namely red and green, from the chromatically interleaved RGB data are advantageously transferred from source memory 100 two bytes at a time and stored as chromatically segregated data in SSE registers 120, reducing relative to conventional approaches the number of memory references performed.

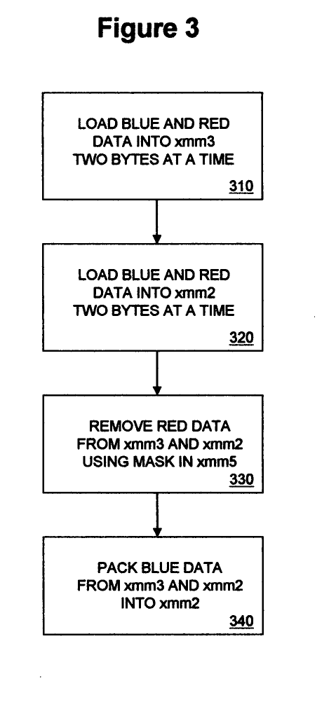

Turning to FIG. 3, a method for loading of chromatically interleaved blue data into an SSE register as chromatically segregated data in some embodiments of the invention will now be described. First, eight bytes each of blue and red data are loaded from source memory 100 into SSE register mmx3. Such loading may be accomplished through execution of eight Packed Insert Word (PINSRW) instructions that cause eight two-byte words of blue and red data (B₀, R₁ through B₇, R₈) to be moved from source memory 100 into SSE register xmm3 (310) while bypassing eight one-byte words of green data (G₀ through G₇). Next, an additional eight bytes each of blue and red data are loaded from source memory 100 into SSE register xmm2. Such loading may be accomplished through execution of eight Packed Insert Word (PINSRW) instructions that cause eight two-byte words (B₈, R₉ through B₁₅, R₁₆), respectively, to be moved from source memory 100 into SSE register xmm2 (320). Then, the red data are removed from SSE registers xmm3 and xmm2 through a masking operation using a mask stored in SSE register xmm5 (330). Such removal may be accomplished through execution of two bitwise logical AND (PAND) instructions. Then, the blue data from xmm3 and xmm2 are packed into xmm2 (340). Such packing may be accomplished through execution of a Packed with Unsigned Saturation (PACKUSWB) instruction.

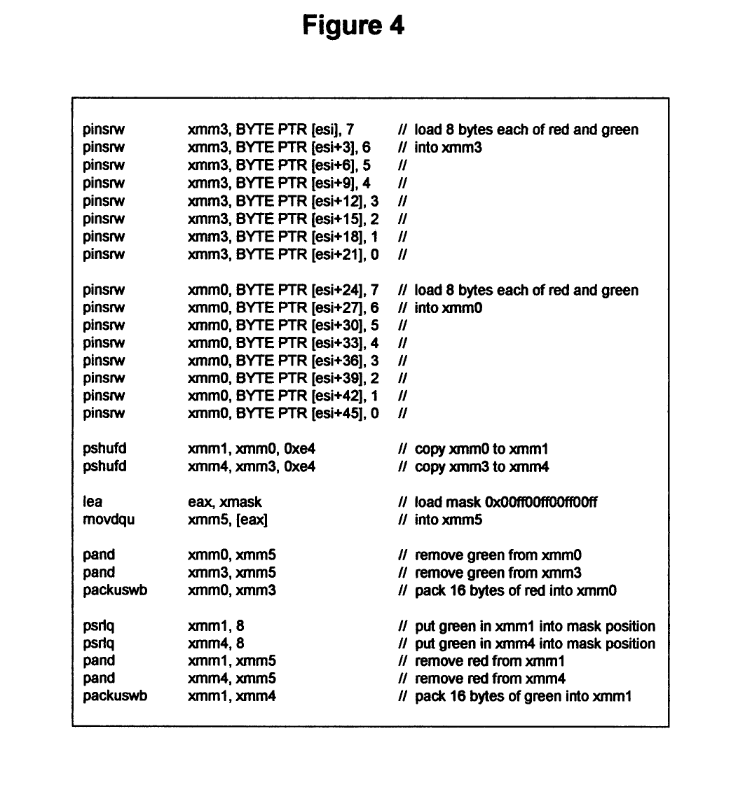

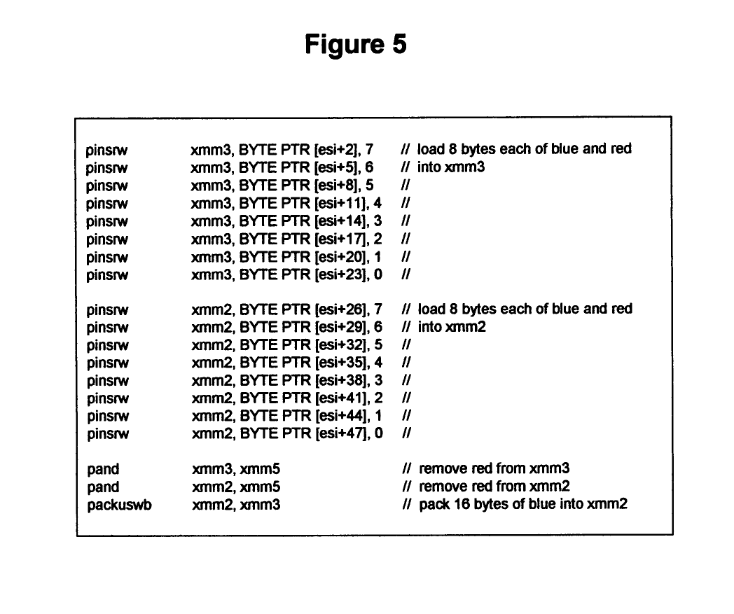

FIGS. 4 and 5 provide exemplary x86 assembly language pseudocode that is executable by an SSE-compliant processor for implementing the methods of FIGS. 2 and 3, respectively, with inserted comments. In the pseudocode, esi is a source register that points to the RGB data.

It will be appreciated that the above embodiments are merely exemplary; in other embodiments of the present invention the order in which the color data are loaded, manipulated and packed and the roles played by the various SSE registers 120 may differ. As one of many examples, green and blue data may be loaded and packed into xmm3 and xmm4, respectively, followed by loading and packing of red data into xmm5. It will therefore be appreciated by those of ordinary skill in the art that the invention can be embodied in other specific forms without departing from the spirit or essential character hereof. The present description is considered in all respects to be illustrative and not restrictive. The scope of the invention is indicated by the appended claims, and all changes that come with in the meaning and range of equivalents thereof are intended to be embraced therein.

What is claimed is:

1. A system for rapid loading of chromatically interleaved red, green and blue (RGB) data as chromatically segregated RGB data, comprising:
processing logic;
a source storage element adapted to store chromatically interleaved RGB data; and
a plurality of destination storage elements, wherein the processing logic is adapted to load into a first two destination storage elements a first instance of data of a first and a second color from the chromatically interleaved RGB data two bytes at a time, copy the first instance of data to a second two destination storage elements to produce a second instance of data, remove one instance of data of the second color from two of the destination storage elements, pack one instance of data of the first color into one of the destination storage elements, remove one instance of data of the first color from two of the destination storage elements and pack one instance of data of the second color into one of the destination storage elements.

2. The system of claim 1, wherein the destination storage elements are Streaming Single Instruction, Multiple Data Extensions (SSE) registers.

3. The system of claim 1, wherein the processing logic is adopted to load, copy, remove and pack data at least in part through execution of one or more SSE instructions.

4. The system of claim 1, wherein the processing logic is adapted to load data at least in part through execution of Packed Insert Word instructions.

5. The system of claim 1, wherein the processing logic is adapted to copy data at least in part through execution of Packed Shuffle Double Word instructions.

6. The system of claim 1, wherein the processing logic is adapted to remove data at least in part through execution of a Load Effective Address, a Move Double Quadword and bitwise logical AND instructions.

7. The system of claim 1, wherein the processing logic is adapted to pack data at least in part through execution of Packed with Unsigned Saturation instructions.

8. The system of claim 1, wherein the processing logic is further adapted to load from the source storage element into a third two destination storage elements data of the first and a third color from the chromatically interleaved RGB data two bytes at a time, remove the data of the first color from the third two destination storage elements and pack the data of the third color into one of the destination storage elements.

9. The system of claim 8, wherein at least one of the third two destination storage elements is selected from among the first two and second two destination storage elements.

10. The system of claim 8, wherein the first, second and third colors are red, green and blue, respectively.

11. The system of claim 1, wherein the processing logic is adapted to remove data at least in part by performing a masking operation.

12. The system of claim 11, wherein the processing logic is adapted to remove data at least in part by performing a shift operation.

13. A method for rapid loading of interleaved RGB data into SSE registers as chromatically segregated RGB data, comprising the steps of:
loading into SSE registers a first instance of data of a first and a second color from interleaved RGB data two bytes at a time;
creating in SSE registers a second instance of the data of the first and second colors;
removing from SSE registers one instance of the data of the second color;
packing into one SSE register one instance of the data of the first color;
removing from SSE registers one instance of the data of the first color; and
packing into one SSE register one instance of the data of the second color.

14. The method of claim 13, further comprising the steps of:
loading in SSE registers an instance of data of the second and a third color from interleaved RGB data two bytes at a time;
removing from SSE registers the data of the second color; and
packing into one SSE register the data of the third color.
